(19) United States
(12) Patent Application Publication
(10) Pub. No.: US 2018/0258682 A1
(43) Pub. Date: Sep. 13, 2018

(54) POWER SWING DOOR DRIVE ACTUATOR

(71) Applicant: Magna Closures Inc., Newmarket (CA)

(72) Inventors: Kurt M. Schatz, Uxbridge (CA); J.R. Scott Mitchell, Newmarket (CA); Gabriele Wayne Sabatini, Keswick (CA); Michael Smart, Keswick (CA)

(21) Appl. No.: 15/910,388

(22) Filed: Mar. 2, 2018

Related U.S. Application Data
(60) Provisional application No. 62/467,959, filed on Mar. 7, 2017.

(51) Int. Cl. E05F 15/622; E05F 15/614; E05F 5/00; F16H 25/20

(52) U.S. Cl. CPC E05F 15/622; F16H 2025/2031; E05F 5/00; F16H 25/2021; E05Y 2201/434; E05Y 2201/686; E05Y 2201/71; E05Y 2600/46; E05Y 2900/531; E05Y 2400/32; E05Y 2400/36; E05Y 2400/40; E05Y 2400/85; E05Y 2400/45; F16H 2025/2043; E05F 15/614

(57) ABSTRACT

A power swing door drive actuator for moving a passenger swing door relative to a body portion of a motor vehicle. The power swing door actuator includes a housing, a motor operably mounted to the housing, and a leadscrew of a spindle drive mechanism rotatably driven by the motor for causing relative translational movement of a drive nut relative to the leadscrew which, in turn, results in the vehicle door swinging between open and closed positions in response to selective actuation of the motor. A first articulation joint unit couples an elongate extensible member fixed to the drive nut to the vehicle body while a second articulation joint unit couples the housing to the vehicle door.

### CROSS-REFERENCE TO RELATED APPLICATION

This application claims the benefit of U.S. Provisional Application Ser. No. 62/467,959, filed Mar. 7, 2017, which is incorporated herein by reference in its entirety.

### FIELD

The present disclosure relates generally to power door systems for motor vehicles and, more particularly, to a power door drive actuator operable for moving a vehicle swing door relative to a vehicle body between an open position and a closed position.

### BACKGROUND

This section provides background information related to the present disclosure which is not necessarily prior art.

The passenger doors on motor vehicles are typically mounted by upper and lower door hinges to the vehicle body for swinging movement about a generally vertical pivot axis. Each door hinge typically includes a door hinge strap connected to the passenger door, a body hinge strap connected to a pillar (i.e. A and B pillar) of the vehicle body, and a pivot pin arranged to pivotably connect the door hinge strap to the body hinge strap and define the vertical pivot axis. Such swinging passenger doors (“swing doors”) have recognized issues such as, for example, when the vehicle is situated on an inclined surface and the swing door either opens too far or swings shut due to the unbalanced weight of the swing door. To address this issue, most passenger swing doors have some type of detent or check mechanism integrated into at least one of the door hinges that functions to inhibit uncontrolled swinging movement of the swing door by positively locating and holding the swing door in one or more mid-travel positions in addition to a fully-open position. In some high-end vehicles, the door hinge may include an infinite door check mechanism which allows the swing door to be opened and held in check at any desired open position. One advantage of passenger swing doors equipped with door hinges having an infinite door check mechanism is that the swing door can be located and held in any position to avoid contact with adjacent vehicles or structures.

As a further advancement, power door actuation systems have been developed which function to automatically swing the passenger swing door about its vertical pivot axis between the open and closed positions. Typically, power door actuation systems include a power-operated device such as, for example, an electric motor and a rotary-to-linear conversion device that are operable for converting the rotary output of the electric motor into translational movement of an extensible member. In most arrangements, the electric motor and the rotary-to-linear conversion device are mounted within an internal cavity of the passenger swing door and the distal end of the extensible member is fixedly secured to the associated pillar (i.e. A and B pillar) of the vehicle body. For example, the power swing door actuator can have a rotary-to-linear conversion device configured to include an externally-threaded leadscrew rotatively driven by the electric motor and an internally-threaded drive nut meshingly engaged with the leadscrew and to which a tubular extensible member is attached. Accordingly, control over the speed and direction of rotation of the leadscrew results in control over the speed and direction of translational movement of the drive nut and the tubular extensible member for controlling swinging movement of the passenger swing door between its open and closed positions.

While such power door actuation systems generally function satisfactorily for their intended purpose, one recognized drawback relates to their packaging requirements within the internal cavity of the swing door. Specifically, since power door actuation systems rely on linear motion of the extensible member, the electric motor and conversion device must necessarily be packaged in a generally horizontal orientation within the internal cavity of the passenger swing door and in generally horizontal alignment with respect to at least one of the door hinges. As such, the application of such conventional power door actuation systems may be limited, particularly to only those vehicular swing doors where such an orientation would not cause interference with existing hardware and mechanisms within the internal cavity, such as for example, the glass window function, the power wiring and harnesses, and the like. Put another way, the translational motion of the extensible member requires the availability of a significant amount of space within the internal cavity of the passenger swing door.

In view of the above, there remains a need to develop alternative power door actuation systems which address and overcome packaging limitation associated with known power door actuation systems as well as to provide increased operating efficiency and applicability while reducing cost and complexity of the power door actuation system.

### SUMMARY

This section provides a general summary of the present disclosure and is not intended to be a comprehensive disclosure of its full scope or to represent all of its features, aspects and objectives, which will be apparent to one possessing ordinary skill in the associated art.

According to an aspect of the present disclosure there is provided a power swing door drive actuator for use in a power swing door actuation system and which is operable for moving a vehicle swing door between open and closed positions relative to a vehicle body.

According to another aspect of the present disclosure there is provided a power swing door drive actuator for use with swing doors in motor vehicles which can be effectively packaged in its entirety within a lower portion of an internal cavity of the swing door and which cooperates with the door hinges of the swing door to facilitate swinging movement of the swing door.

According to another aspect of the present disclosure there is provided a power swing door actuator having a mounting unit, a power-operated drive mechanism supported by the mounting unit and having an extensible actuation member, and a coupling mechanism having a first articulation joint unit arranged to pivotably connect the mounting unit to the swing door and a second articulating joint unit arranged to pivotably connect the extensible actuation member to the vehicle body.

According to another aspect of the present disclosure there is provided an arrangement of the first articulation joint unit to pivotably connect to a surface within the internal cavity of the swing door and an arrangement of the second articulation joint unit to pivotably connect the extensible actuation member to a door sill of the vehicle body in spaced relation from a pivot axis of the swing door.

According to another aspect of the present disclosure there is provided the power-operated drive mechanism of the power swing door actuator having a motor-driven spindle unit configured to convert rotation of a leadscrew into linear movement of a drive nut for translating a tubular actuation member of the power swing door actuator.

In accordance with these and other aspects, the power swing door actuator of the present disclosure is configured for use in a power door actuation system in a motor vehicle having a vehicle body defining a door opening and a swing door pivotably connected to the vehicle body for movement about a pivot axis along a swing path between open and closed positions. The power swing door actuator includes a power-operated drive mechanism connected by a first spherical joint unit to a lower portion of the swing door and having a linearly moveable actuation member connected via a second spherical joint unit to the vehicle body in spaced relation from the pivot axis. Linear movement of the actuation member in a first direction causes the swing door to move in an opening direction from the closed position toward the open position while linear movement of the actuation member in a second direction causes the swing door to move in a closing direction from the open position toward the closed position. The first and second spherical joint units associated with the coupling mechanism are operable to accommodate pivotal movement of the vehicle door along its hinged swing path in cooperation with bi-directional linear movement of the tubular actuation member.

Further areas of applicability will become apparent from the description provided herein. The description and specific embodiments listed in this summary are for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a side view of an example motor vehicle equipped with a power door actuation system situated between a passenger swing door and the vehicle body and which is constructed in accordance with the teachings of the present disclosure;

FIG. 2 is a schematic, partially broken away view of a front passenger swing door shown in FIG. 1, with various components removed for clarity purposes only, which is equipped with a power door actuation system of the present disclosure;

FIGS. 3A, 3B and 3C are schematic views of a power swing door drive actuator associated with the power door actuation system of the present disclosure and which is operably arranged between the vehicle body and the swing door for moving the swing door between a closed position, one or more mid-positions, and an open position, respectively;

FIG. 4 is a sectional view of the power swing door actuator shown in FIGS. 3A, 3B and 3C;

FIGS. 5A and 5B are exploded and assembled views, respectively, of a slip clutch associated with the swing door actuator shown in FIG. 4;

FIG. 6 is a view similar to FIG. 1 of an example motor vehicle equipped with a power door actuation system in association with a front passenger swing door and having a power swing door drive actuator constructed according to another aspect of the present disclosure;

FIG. 7 is a perspective view of the vehicle shown in FIG. 6 with the front passenger swing door moved to a fully-open position to better illustrate the location of the power swing door drive actuator;

FIG. 8 is an enlarged perspective view of a portion of FIG. 7 providing further clarity of the structure and location of the power swing door drive actuator;

FIG. 9 is a top view of the powered vehicle swing door associated with the vehicle shown in FIGS. 6-8 with the passenger swing door in the closed position;

FIG. 10 is a similar view to FIG. 9 with the passenger swing door shown in an intermediate open position;

FIG. 11 is a similar view to FIG. 10 with the passenger swing door shown in a fully open position;

FIG. 12 is a side view of the powered vehicle door associated with the vehicle shown in FIGS. 6-11 with the passenger swing door in the closed position; and

FIG. 13 is a similar view to FIG. 12 with the passenger swing door in the open position.

### DETAILED DESCRIPTION OF EXAMPLE EMBODIMENTS

In general, example embodiments of a power door actuation system having a power swing door drive actuator constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

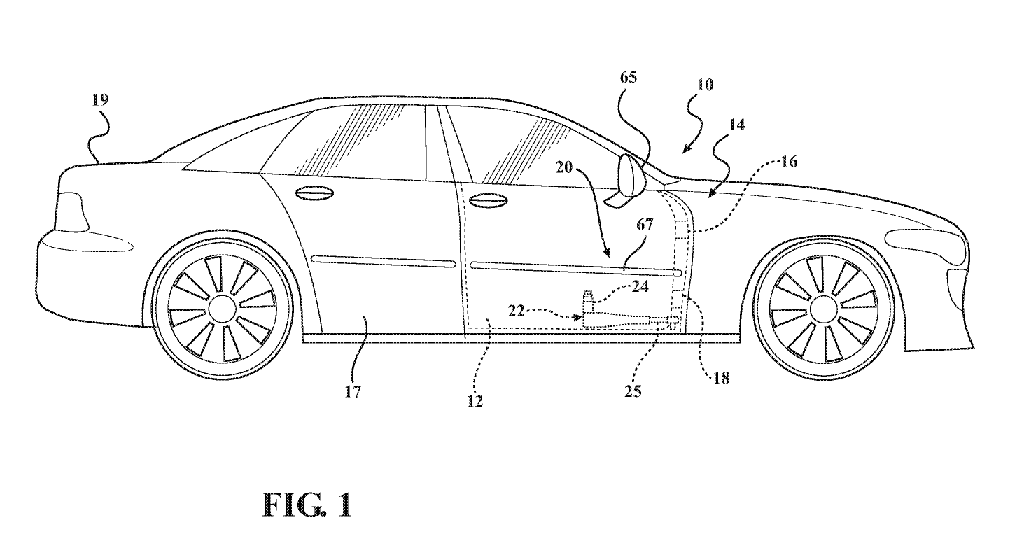

Referring initially to FIG. 1, an example motor vehicle 10 is shown to include a passenger-side front door 12 pivotally mounted to a vehicle body 14 via an upper door hinge 16 and a lower door hinge 18, which are both shown in phantom lines. In accordance with a general aspect of the present disclosure, a power door actuation system 20, also shown in phantom lines, is integrated into the pivotal connection between front door 12 and the vehicle body 14. In accordance with an exemplary configuration, power door drive actuation system 20 generally includes a power-operated swing door drive actuator 22 secured within an interior chamber, also referred to as internal cavity 34, of front door 12. The power-operated swing door drive actuator 22 includes an electric motor 24 configured to drive a spindle drive unit having a tubular extensible actuation component or member 25 that is pivotably coupled to a portion of the vehicle body 14. Driven rotation of the spindle drive unit via actuation of the electric motor 24 causes controlled pivotal movement of front door 12 relative to vehicle body 14.

Each of upper door hinge 16 and lower door hinge 18 include a door-mounting hinge component and a body-mounted hinge component that are pivotably interconnected by a hinge pin or post. While power door actuation system 20 is only shown in association with front door 12, those skilled in the art will recognize that power door actuation system 20 can also be associated with any other door or liftgate of vehicle 10 such as rear doors 17 and decklid 19.

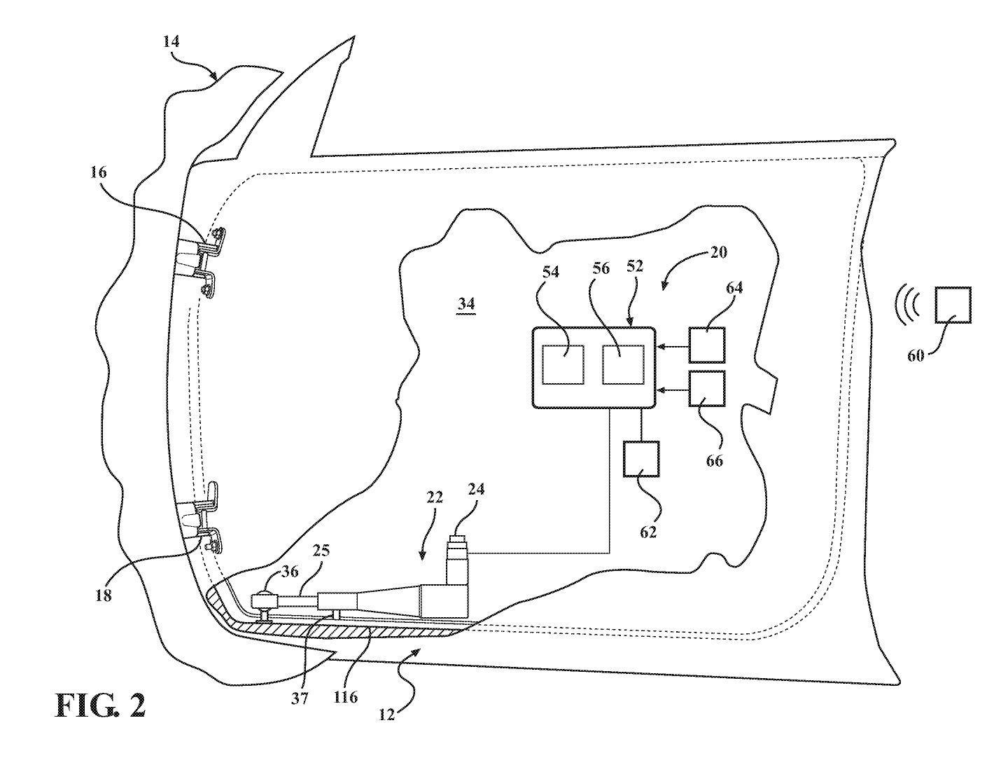

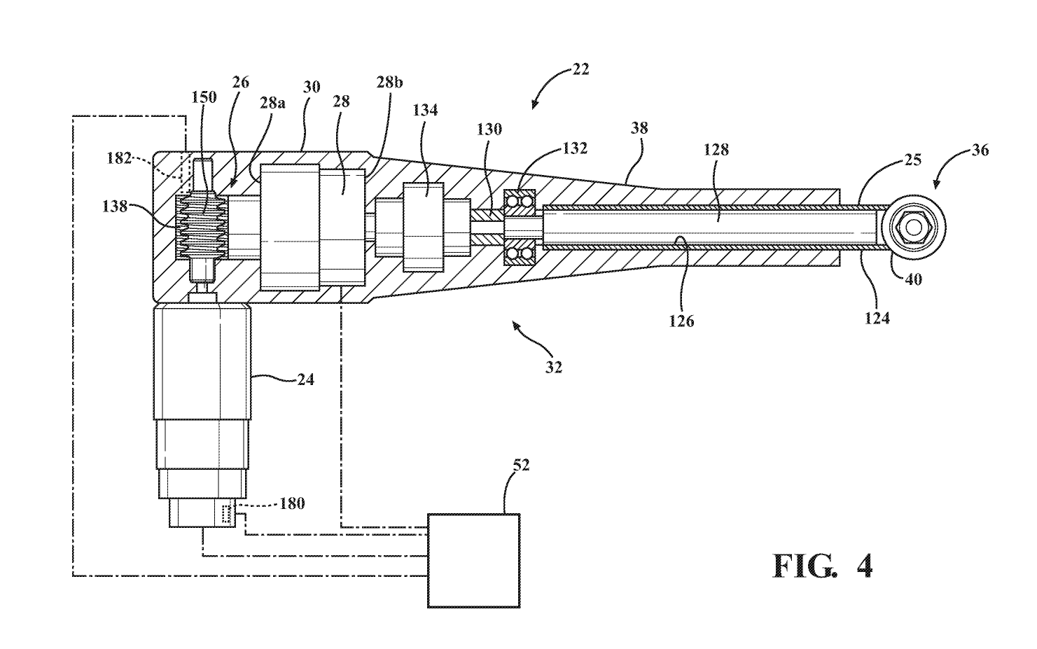

Power door actuation system 20 is diagrammatically shown in FIG. 2 to include power swing door drive actuator 22 comprised of the electric motor 24, and as best shown in FIG. 4, a reduction geartrain 26, a slip clutch 28, and a drive mechanism 30 which together define a powered door actuator assembly 32 that is mounted within an interior chamber, also referred to as interior or internal cavity 34, of door 12 between inner and outer panels of the door 12. Power swing door actuator 22 also includes a first connector mechanism 36 configured to connect a terminal end 40 of the extensible actuation member 25 of drive mechanism 30 to vehicle body 14 and further includes a support structure, such as an actuator housing 38, configured to be secured to swing door 12 within a lowermost region of interior chamber 34, such as to a lowermost wall delimiting a lowermost portion of interior chamber 34, also referred to as floor 31, via a second connector mechanism 37 and to enclose or operably attach to electric motor 24, and to enclose reduction geartrain 26, slip clutch 28 and drive mechanism 30 therein. Power swing door actuator assembly 32 is shown in this non-limiting arrangement to be located below lower hinge 18 in a lowermost region of interior chamber 34. As also shown in FIG. 2, an electronic control module 52 is in communication with electric motor 24 for providing electric control signals thereto. Electronic control module 52 includes a microprocessor 54 and a memory 56 having executable computer readable instructions stored thereon for commanding movement and control of the power-operated swing door drive actuator 22. Electronic control module 52 can be integrated into, directly connected to actuator housing 38, or otherwise electrically coupled for communication with motor 24.

Although not expressly illustrated, electric motor 24 can include Hall-effect sensors for monitoring a position and speed of vehicle door 12 during movement between its open and closed positions. For example, one or more Hall-effect sensors may be provided and positioned to send signals to electronic control module 52 that are indicative of rotational movement of electric motor 24 and indicative of the rotational speed of electric motor 24, e.g., based on counting signals from the Hall-effect sensor detecting a target on a motor output shaft. In situations where the sensed motor speed is greater than a threshold speed and where a current sensor registers a significant change in the current draw, electronic control module 52 may determine that the user is manually moving door 12 while motor 24 is also operating, thus moving vehicle door 12 between its open and closed positions. Electronic control module 52 may then send a signal to electric motor 24 to stop motor 24 and may even disengage slip clutch 28 (if provided). Conversely, when electronic control module 52 is in a power open or power close mode and the Hall-effect sensors indicate that a speed of electric motor 24 is less than a threshold speed (e.g., zero) and a current spike is registered, electronic control module 52 may determine that an obstacle is in the way of vehicle door 12, in which case the electronic control system may take any suitable action, such as sending a signal to turn off electric motor 24. As such, electronic control module 52 receives feedback from the Hall-effect sensors to ensure that a contact obstacle has not occurred during movement of vehicle door 12 from the closed position to the open position, or vice versa.

As is also schematically shown in FIG. 2, electronic control module 52 can be in communication with a remote key fob 60 and/or with an internal/external handle switch 62 for receiving a request from a user to open or close vehicle door 12. Put another way, electronic control module 52 receives a command signal from either remote key fob 60 and/or internal/external handle switch 62 to initiate an opening or closing of vehicle door 12. Upon receiving a command, electronic control module 52 proceeds to provide a signal to electric motor 24 in the form of a pulse width modulated voltage (for speed control) to turn on electric motor 24 and initiate pivotal swinging movement of vehicle door 12. While providing the signal, electronic control module 52 also obtains feedback from the Hall-effect sensors of electric motor 24 to ensure that a contact obstacle has not occurred. If no obstacle is present, electric motor 24 will continue to generate a rotational force to actuate spindle drive mechanism 30. Once vehicle swing door 12 is positioned at the desired location, electric motor 24 is turned off and the “self-locking” gearing associated with reduction geartrain 26 causes vehicle swing door 12 to continue to be held at that location. If a user tries to move vehicle swing door 12 to a different operating position, electric motor 24 will first resist the user's motion (thereby replicating a door check function) and eventually release and allow the vehicle swing door 12 to move to the newly desired location. Again, once vehicle swing door 12 is stopped, electronic control module 52 will provide the required power to electric motor 24 to hold it in that position. If the user provides a sufficiently large motion input to vehicle swing door 12 (i.e., as is the case when the user wants to close the swing door 12), electronic control module 52 will recognize this motion via the Hall effect pulses and proceed to execute a full closing operation for vehicle door 12.

Electronic control module 52 can also receive an additional input from an ultrasonic sensor 64 positioned on a portion of vehicle door 12, such as on a door mirror 65 or the like. Other types of proximity sensors, such as radar or other electromechanical-based proximity sensor can be used. Ultrasonic sensor 64 assesses if an obstacle, such as another car, tree, or post, is near or in close proximity to vehicle door 12. If such an obstacle is present, ultrasonic sensor 64 will send a signal to electronic control module 52 and electronic control module 52 will proceed to turn off electric motor 24 to stop movement of vehicle door 12, thereby preventing vehicle door 12 from hitting the obstacle. This provides a non-contact obstacle avoidance system. In addition, or optionally, a contact obstacle avoidance system can be placed in vehicle 10 which includes a contact sensor 66 mounted to door, such as in association with molding component 67, and which is operable to send a signal to controller 52.

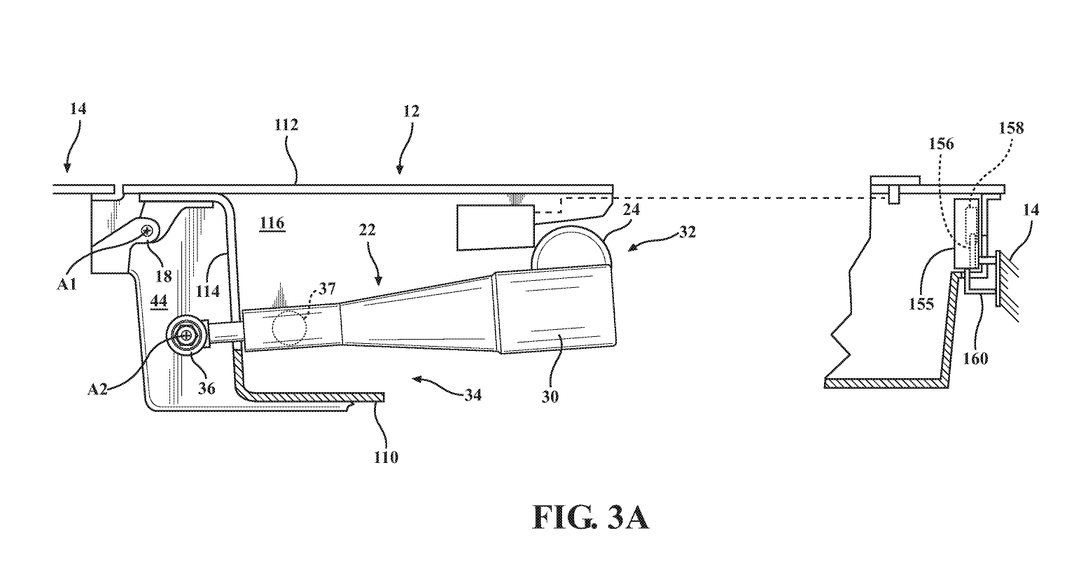

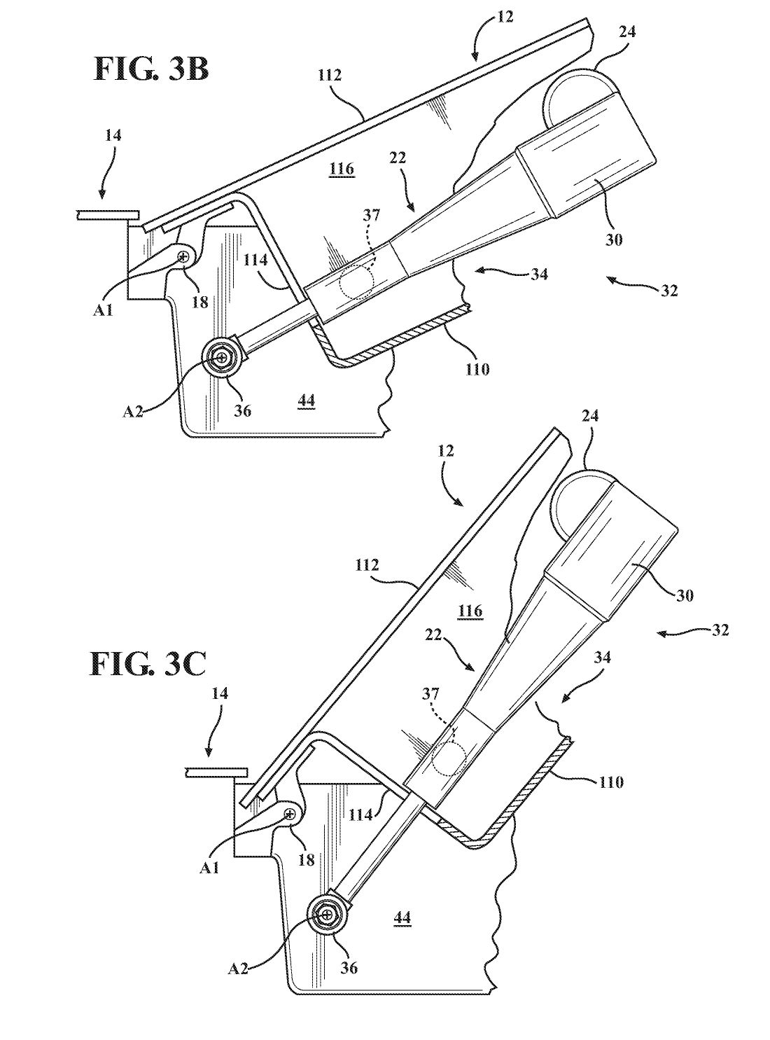

FIGS. 3A, 3B and 3C show a non-limiting embodiment of the power-operated swing door drive actuator 22 in operation to move the vehicular swing door 12 between a closed position, an intermediate open position, and a fully-open position, respectively. The swing door 12 is pivotally mounted by the aforementioned pair of upper and lower door hinges, with only the lower door hinge 18 shown, connected to the vehicle body 14 (not shown in its entirety) for rotation about a generally vertical door hinge axis A1. For greater clarity, the vehicle body 14 is intended to include the ‘non-moving’ structural elements of the vehicle 10 such as the vehicle frame (not shown) and body panels (not shown).

The swing door 12 includes inner and outer sheet metal panels 110 and 112 with a connecting portion 114 between the inner and outer sheet metal panels 110 and 112. The power-operated swing door drive actuator 22 is shown including a support structure, such as the housing 38, the power-operated drive mechanism 30 mounted within housing 38, and the extensible actuation member 25 drivingly coupled to power-operated drive mechanism 30. The extensible actuation member 25 is moveable relative to housing 38 between retracted and extended positions to effectuate swinging movement of swing door 12. The power-operated swing door drive actuator 22 is mounted within the lowermost region of the internal door cavity 34 formed between the inner and outer sheet metal panels 110, 112. Specifically, the actuator housing 38 is fixed to the swing door 12 via the second connector mechanism 37 mounted to the connecting door portion 114 immediately adjacent a bottom wall, also referred to as floor 116, within the internal door cavity 34. The terminal end 40 of the extensible actuation member 25 is mounted to the vehicle body 14 below the lower door hinge 18 in laterally spaced relation from the door hinge axis A1, such that a pivot axis A2 of the terminal end 40 is laterally spaced from door hinge axis A1, thereby providing a lever or moment arm for enhanced pivotal movement of swing door 12. It is recognized that the provision of a laterally offset door hinge axis A1 and pivot axis A2 can provide a moment arm and increase mechanical advantage such that a smaller, less powerful power-operated swing door drive actuator 22 may be provided to open and close the swing door 12 as compared to a mounting of a power-operated swing door drive actuator to a shut face 31 to which upper and lower door hinges 16, 18 are fixed and whereat the door hinge axis and the pivot axis are not laterally spaced apart from one another or the lateral spacing is limited by the width of the shut face 31, and not as great as a lateral spacing as available in the embodiment where the terminal end 40 is connected to a horizontally extending door sill, also referred to as rocker panel 44. It is also recognized that the terminal end 40 is connected to the rocker panel 44 relative to the door hinge axis A1 at a location that can allow the swing door 12 to be opened at a wider angle relative to the vehicle body 14, i.e. away from the body 14 up to a perpendicular, or greater than perpendicular relationship with the body 14. It is also recognized that mounting the terminal end 40 to the rocker panel 44 can provide different mounting options as compared to the shut face 31, due to the shut face 31 being populated with the hinge mounting points, apertures for wires, air ducts, and door checks at other connections. While mounting the terminal end 40 to the shut face 31 is possible, the mounting to the rocket panel 44 offers less obstacles in positioning and increase leverage, as discussed above.

Referring additionally to the sectional view of the power-operated swing door drive actuator 22 shown in FIG. 4, the housing 38 defines a cylindrical chamber in which the tubular extensible actuation member 25 slides. The extensible actuation member 25 includes the first connector mechanism 36, such as one of a ball or ball socket at the terminal end 40 of a cylindrical tube 124 for pivotal attachment to the other of a corresponding ball or ball socket on the vehicle body 14. The cylindrical tube 124 is formed to include internal threads 126. The internally-threaded cylindrical tube 124 (also referred to as a “nut tube”) meshingly engages with external threads formed on a rotary drive member, i.e. lead screw 128 that is mounted in the housing 38 for rotation in situ. The lead screw 128 is matable with the internally-threaded nut tube 124 to permit relative rotation between lead screw 128 and the internally-threaded nut tube 124. In the embodiment shown, because the nut tube 124 is slidably connected in the housing 38 but is held against rotation, as the lead screw 128 rotates the nut tube 124 translates linearly, thereby causing the extensible actuation member 25 to move with respect to the housing 38. Since the extensible actuation member 25 is connected to the vehicle body 14 and the actuator housing 38 is connected to the swing door 12, such movement of the extensible actuation member 25 causes the swing door 12 to pivot relative to the vehicle body 14.

The lead screw 128 is connected to a shaft 130 that is journalled in the housing 38 via ball bearing 132 that provides radial and linear support for the lead screw 128. In the illustrated non-limiting embodiment, an absolute position sensor 134 is mounted to the shaft 130. The absolute position sensor 134 translates lead screw rotations into an absolute linear position signal so that the linear position of the extensible actuation member 25 is known with certainty, even upon power up. In alternative embodiments, the absolute linear position sensor 134 can be provided by a linear encoder mounted between the nut tube 124 and actuator housing 38 which reads the travel between these components along a longitudinal axis.

The shaft 130 is connected to the clutch unit 28 associated with the power-operated drive mechanism 30. The clutch unit 28 is normally operable in an engaged mode and must be energized to shift into a disengaged mode. In other words, the clutch unit 28 normally couples the lead screw 128 with the geartrain unit 26 without the application of electrical power and the clutch unit 28 requires the application of electrical power to uncouple the lead screw 128 from the geartrain unit 26. The clutch unit 28 may engage and disengage using any suitable type of clutching mechanism, such as a set of sprags, rollers, a wrap-spring, a pair of friction plates, or any other suitable mechanism. The geartrain unit 26 is also part of power-operated drive mechanism 30.

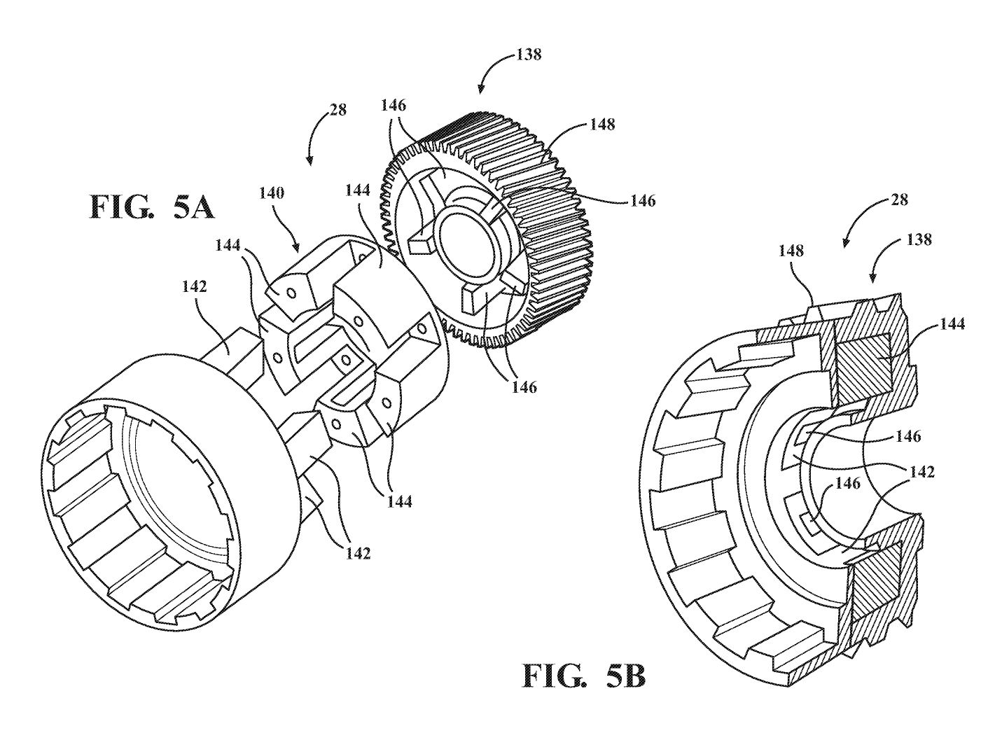

Referring additionally to FIGS. 5A and 5B, the clutch unit 28 is connected to a worm gear 138 via a flexible rubber coupling 140. Clutch unit 28 features a series of lobes 142 that are interdigitated with nodules 144 of the flexible rubber coupling 140 and fins 146 of the worm gear 138. The flexible rubber coupling 140 helps to reduce gear noise by dampening vibrations and minimizing the effects of any misalignment between the clutch unit 28 and the geartrain unit 26.

The worm gear 138 may be a helical gear having gear teeth 148. The worm gear 138 meshes with a worm 150 (FIG. 4) that is connected to the output shaft of the electric motor 24, which may, for example, be a fractional horsepower motor. The worm 150 may be a single start worm having a thread with a lead angle of less than about 4 degrees, by way of example and without limitation. The geartrain unit 26 is thus provided by the worm 150 and worm gear 138 and provides a gear ratio that multiplies the torque of the motor as necessary to drive the lead screw 128 and move the vehicle swing door 12. The electric motor 24 is operatively connected to the geartrain unit 26 and is operatively connected to an input end 28a of the clutch unit 28 through the geartrain unit 26. The output end (shown at 28b) of the clutch unit 28 is operatively connected to the extensible actuation member 25 (in the embodiment shown, through the lead screw 128 and nut tube 124). In this non-limiting arrangement, the power-operated drive mechanism 30 includes the electric motor 24, the geartrain unit 26, the clutch unit 28, the position sensor 134, and the spindle drive unit comprised of leadscrew 128 and nut tube 124. Thus, actuator 22 is configured as an electromechanical strut.

The worm 150 and worm gear 138 provide a locking geartrain, which may also be referred to as a geartrain that is non-back drivable. With the clutch unit 28 normally engaged, a relatively large amount of force is required to back-drive the geartrain unit 26 and motor 24. Thus, the power-operated swing door drive actuator 22 inherently provides an infinite door check function as the force required to back-drive the geartrain unit 26 and motor 24 will be much larger than the force experienced by an unbalanced door as a result of the vehicle being situated on an incline.

However, the clutch unit 28 has an associated slip torque between the input end 28a and the output end 28b, that is a maximum amount of torque that the clutch unit 28 will transmit between the input and output ends 28a and 28b before slipping. Thus, when the clutch unit 28 is engaged, it will slip if a torque is applied at the input end 28a (or at the output end 28b) that exceeds the slip torque. The slip torque for the clutch unit 28 may be selected to be sufficiently low that, in the event of a power loss in the vehicle that would result in no electric power being available to disengage the clutch 28, the swing door 12 can still be manually moved by a person by overcoming the clutch slip torque. However, the slip torque may be selected to be sufficiently high so that it is sufficient to hold the swing door 12 in whatever position the swing door 12 is in, thereby providing the infinite door check function. In other words, the slip torque is sufficiently high that, if the swing door 12 is left in a particular position and the motor 24 is stopped, the slip torque will prevent movement of the swing door 12 when the swing door 12 is exposed to an external torque that is less than a selected value. An example of an external torque that would not overcome the slip torque would be applied by the weight of the swing door 12 when the vehicle 10 is parked on a surface at less than a selected angle of incline. However, the slip torque is sufficiently low that the swing door 12 can be moved manually by a person (e.g. a person having a selected strength that would be representative of a selected percentage of the overall population in which the vehicle 10 is to be sold).

In normal operation, the power-operated swing door drive actuator 22 can be disengaged to allow for manual movement of the swing door 12 by applying power (i.e. energizing) to the clutch unit 28, in which case the electric motor 24 and the geartrain unit 26 will be decoupled from the lead screw 128. An example of a suitable slip torque that may be selected for the clutch unit 28 may be in the range of about 2 Nm to about 4 Nm. The slip torque that is selected for a particular application may depend on one or more of several factors. An example factor based on which the slip torque may be selected is the weight of the swing door 12. Another example factor based on which the slip torque may be selected is the geometry of the swing door 12. Yet another example factor based on which the slip torque may be selected is the amount of incline on which the vehicle 10 is intended to be parked while still ensuring that the swing door 12 is holdable in any position.

A swing door actuation system is provided that includes the power-operated swing door drive actuator 22 and the control system or module 52 shown schematically in FIG. 4. The control system 52 may also be operatively connected to a door latch, shown at 155 in FIG. 3A, that is provided as part of the swing door 12. The door latch 155 may include a latch mechanism having a ratchet 156 and a pawl 158, both of which may be any suitable ratchet and pawl known in the art. The ratchet 156 is movable between a closed position wherein the ratchet 156 holds a striker 160 that is mounted to the vehicle body 14 and an open position wherein the striker 160 is not held by the ratchet 156. When the ratchet 156 is in the closed position, the door latch 155 may be said to be closed (FIGS. 1, 3A). When the ratchet 156 is in the open position, the door latch 155 may be said to be open (FIGS. 3B, 3C). The pawl 158 is movable between a ratchet locking position wherein the pawl 158 holds the ratchet 156 in the closed position and a ratchet release position wherein the pawl 158 permits movement of the ratchet 156 to the open position. Any other suitable components may be provided as part of the door latch 155, such as components for locking and unlocking the swing door 12, and motors for causing movement of the pawl 158 between the ratchet locking and ratchet release positions.

The control system 52 provides system logic for selectively powering the electric motor 24 and the clutch unit 28 based on a number of signal inputs. The control system 52 may include the microprocessor 54 and memory 56 that contains programming that is configured to carry out the method steps described below, and may be configured to receive inputs and transmit outputs as described below.

While the non-limiting example of the control system 52 has been shown in FIG. 4 as a single block, it will be understood by persons skilled in the art that in practice the control system 52 may be a complex distributed control system having multiple individual controllers connected to one another over a network.

The swing door 12 may have a conventional opening lever (not shown) located inside the passenger compartment for manually opening the door latch 155. This opening lever may trigger a switch connected to the control system 52 such that, when the switch is actuated, the control system 52 powers (i.e. energizes) the clutch unit 28 to disengage the power-operated swing door drive actuator 22 and allow for manual movement of the swing door 12.

The control system 52 can operate in a ‘power assist’ mode where the control system 52 determines that a user is trying to manually move the swing door 12 when the power-operated swing door drive actuator 22 is in a power open or power close mode. A current sensor 180 (FIG. 4) may be provided for the electric motor 24 for determining the amount of current drawn by the motor 24. One or more Hall-effect sensors (one is shown at 182) may be provided and positioned to send signals to the control system 52 that are indicative of rotational movement of the motor electric 24 and indicative of the rotational speed of the electric motor 24, e.g. based on counting signals from the Hall-effect sensor 182 detecting a target on the motor output shaft. In situations where the sensed motor speed is greater than a threshold speed and where the current sensor registers a significant change in the current draw, the control system 52 may determine that the user is manually moving the swing door 12 while the electric motor 24 is also moving the swing door 12, and that therefore the user wishes to manually move the swing door 12. The control system 52 may then stop the electric motor 24 and may energize and thus disengage the clutch 28. Conversely, when the control system 52 is in the power open or close mode and the Hall-effect sensors indicate that the motor speed is less than a threshold speed (e.g. zero) and a current spike is registered, the control system 52 may determine that an obstacle is in the way of the swing door 12, in which case the control system 52 may take any suitable action, such as stopping the electric motor 24. As an alternative, the control system 52 may detect that the user wants to initiate manual movement of the swing door 12 if signals from the absolute position sensor 134 indicate movement of the extensible member at a time when the swing motor 24 is not powered.

The swing door actuation systems of the present disclosure enable a powered open and powered close of the vehicular swing door 12, where the normally engaged clutch 28 enables the motor 24 and the gear train 26 to rotatably drive the lead screw 128 in order to expand and retract the tubular cylinder nut 124 resulting in extension and retraction of the extensible actuation member 25 for opening and closing the swing door 12. The swing door actuation system also enables the user to manually open and close the vehicle swing door 12 by powering the clutch 28 to disengage the geartrain 26 and the motor 24 in a manual mode wherein only the lead screw 128 is back-driven during manual movement with relatively low manual effort and noise. Disengagement of the clutch 28 eliminates the effort and noise that is associated with back-driving the geartrain 26 and the motor 24. As a result, the manual effort to move the swing door 12 may be similar in some embodiments, to a conventional non-powered vehicle door. When the clutch 28 is engaged, an infinite position door check function is provided, via engagement of the lead screw 128 to the geartrain 26 (and in particular to the worm 150, which has a thread angle configured to prevent back-driving from the worm gear 138). As a result of the normally-engaged clutch 28, the infinite door check function is available in the event of vehicle power loss thereby precluding an uncontrolled swinging of the swing door 12 during such a power loss event. However, the user can still manually move the swing door 12 open and closed in a power loss event by overcoming an appropriately selected slip torque of the clutch 28. Additionally, the clutch 28 protects the swing door actuation system from shock and abuse loading.

The swing door actuation systems of the present disclosure provide a means for speed control and obstacle detection. Speed control is attained by the control system 52 monitoring the Hall-effect signals and/or the absolute position sensor signal. Either signal could be eliminated depending on the desired control features and redundancy requirements. The absolute position sensor is however highly desired for providing the position of the door upon power up or in case of power loss.

The swing door actuation systems of the present disclosure also provide acceptable sound levels during power and manual operation. This is attained in power mode through proper alignment of gears, proper support of the lead screw and flexibly coupling the gear train and lead screw. Acceptable sound levels are attained in manual mode by disengaging the geartrain 26 and electric motor 24 for manual operation.

The swing door actuation systems of the present disclosure may be suitable for packaging and mounting to a typical vehicle swing door 12. The second connector mechanism 37 could be in the front (as shown in FIG. 3) of the power-operated swing door drive actuator 22 or in the rear depending on the packaging objectives. The electric motor 24 may be aligned in a parallel orientation with the housing rather than perpendicular to it, as shown and discussed below in accordance with a further aspect of the disclosure.

It will be noted that the lead screw 128 and the nut tube 124 are just one example of an operative connection between the output end 28b of the clutch 28 and the extensible actuation member 25. Any other suitable operative connection may be provided between the output end 28b of the clutch 28 to the extensible actuation member 25 for converting the rotary motion of the output end 28b into extension and retraction of the extensible actuation member 25. Furthermore, the lead screw 128 and nut tube 124 are just one example of a rotary-to-linear conversion mechanism operable to convert rotary motion (i.e. the rotary motion associated with the output end 28b of the clutch 28) into substantially linear motion which drives the extension and retraction of the extensible actuation member 25 relative to the housing 38. The power-operated swing door drive actuator 22 need not include lead screw 128 and nut tube 124 to convert the rotary motion at the output end 28b of the clutch 28 into linear motion of the extensible actuation member 25. Any other suitable mechanism for carrying out such a conversion may be used. For example, the output end 28b of the clutch 28 may connect to a pair of bevel gears to change the axis of the rotary motion by 90 degrees. The second bevel gear may co-rotate with a spur gear, which in turn drives a rack that is connected to the extensible actuation member 25. As a result, the rotation at the output end 28b of the clutch 28 is converted into linear movement of the rack and the extensible actuation member 25. While the lead screw 128 and the nut tube 124, and the gears and rack described above generate pure linear motion of the extensible member (relative to the housing 38), it is possible to instead provide a mechanism that results in substantially linear motion, which may include motion along a relatively large diameter arc, for example. Such motion along a large diameter arc could drive an arcuate extensible member to move along an arcuate path during extension and retraction of the extensible actuation member 25 from the housing 38. In such instances, the housing 38 itself may be slightly arcuate. Such motion of an extensible actuation member 25 would still be effective in driving the opening and closing of the swing door 12.

The power-operated swing door drive actuator 22 shown and described in relation to FIGS. 1 through 4 of the drawings utilizes the first pivotal connector mechanism 36 between the terminal end 40 of extensible actuation member 25 and the vehicle body 14 below the lower door hinge 18, such as to rocker panel 44, established via a first pivot joint, such as a ball and socket type joint, and utilizes the second pivotal connector mechanism 37 between a second pivotal connection between the housing 38 and the lowermost surface (i.e. floor 31) delimiting the interior chamber 34 established via a second pivot joint, such as a ball and socket type joint. Optionally, a reinforcement member, such as a plate 39, may be provided between the second pivot connector mechanism 37 and the floor 31. As seen from FIGS. 3A-3C, the interior chamber 34 between outer door panel 112 and inner door panel 110 must be sized to accommodate pivotal movement of actuator housing 38 therein.

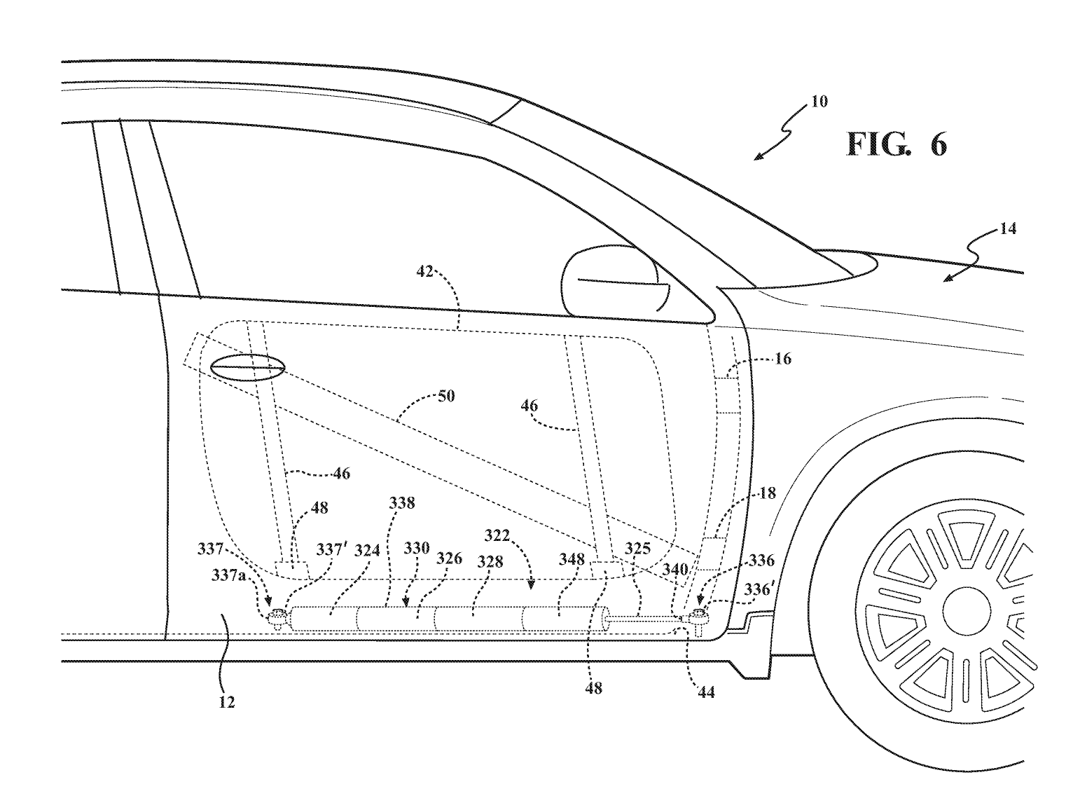

As an alternative, another version of a power swing door drive actuator is shown and described in reference to FIGS. 6-12 and is hereinafter identified by reference numeral 322, wherein the same references numerals as used above, offset by a factor of 300, are used to identify similar features. Power swing door drive actuator 322 can be substituted into vehicle 10 for use in place of power swing door drive actuator 22 to interconnect vehicle swing door 12 to vehicle body 14 for pivotal movement about door hinge axis A1, as well as readily substituted for power-operated swing door drive actuator 22 installed between the swing door 12 and the vehicle body 14. Thus, the following detailed description of power swing door drive actuator 322 is intended to be applicable for use and control within the vehicle applications and control logic previously disclosed herein.

Power swing door drive actuator 322 is shown to generally include a power-operated drive mechanism 330 and a pair of articulating joint mechanisms, also referred to as pivotal connector mechanisms or first and second coupling mechanisms 336, 337, respectively. Power-operated drive mechanism 330 is adapted to be secured within a lowermost portion of an internal door cavity 34 formed in the vehicle swing door 12 and is operable to selectively move an extensible actuation member 325 between retracted and extended positions. Power-operated drive mechanism 330 may include, in this non-limiting embodiment, an electric motor 324, a reduction geartrain unit 326, a slip clutch unit 328, and a spindle drive unit 348. First coupling mechanism 336 includes a first spherical joint unit 336′ connecting a terminal end 340 of extensible member 325 for multi-axis articulation relative to vehicle body 14. Similarly, second coupling mechanism 337 includes a second spherical joint unit 337′ connecting a housing 338 of power-operated drive mechanism 330 for multi-axis articulation relative to door 12. An integrated controller unit may also be provided in association with power swing door drive actuator 322 and may include a printed circuit board (not shown) and electronic circuitry and components required to control actuation of the electric motor 324, all of which are mounted within a controller housing. As seen, power swing door drive actuator 322 is aligned along a lowermost portion of vehicle door 12 below lower hinge 18.

The electric motor 324 may include a rotary output shaft driving an input gear component of the geartrain unit 326 which, in turn, drives an output gear component of the geartrain unit 326 at a reduced speed and with a multiplied torque. The output gear component of the geartrain unit 326 drives an input clutch member of the clutch unit 328 which, in turn, drives an output clutch member of the clutch unit 328 until a predetermined slip torque is applied therebetween. The output clutch member of the clutch unit 328 drives a rotary component of the spindle drive unit 348 which, in turn, is converted into linear, non-rotary movement of extensible actuation member 325. In the non-limiting arrangement shown, the rotary component of the spindle drive unit 348 is an externally-threaded leadscrew. The spindle drive unit 348 also includes an internally-threaded drive nut in threaded engagement with the externally-threaded leadscrew. The drive nut is directly connected to the non-rotary, linearly moveable, extensible actuation member 325 of the power-operated drive mechanism 330 shown to be a tubular elongated drive tube. First coupling mechanism 336 includes first spherical joint unit 336′ having a female or cup-shaped spherical joint member 336a fixed to the terminal end 340 of extensible actuation member 325 that is articulatable about axis A2, which is laterally spaced from door hinge axis A1, as discussed above, with respect to a male or ball-shaped spherical joint member 336b fixed to horizontally extending rocker panel 44 of vehicle body 14 adjacent a lower portion of the A-pillar. Similarly, second coupling mechanism 337 includes second spherical joint unit 337′ having a female or cup-shaped spherical joint member 337a fixed to a portion of housing 314 that is articulatable with respect to a male or ball-shaped spherical joint member 337b fixed to a lowermost surface, i.e. floor 31, inside door internal chamber or cavity 34 of door 12.

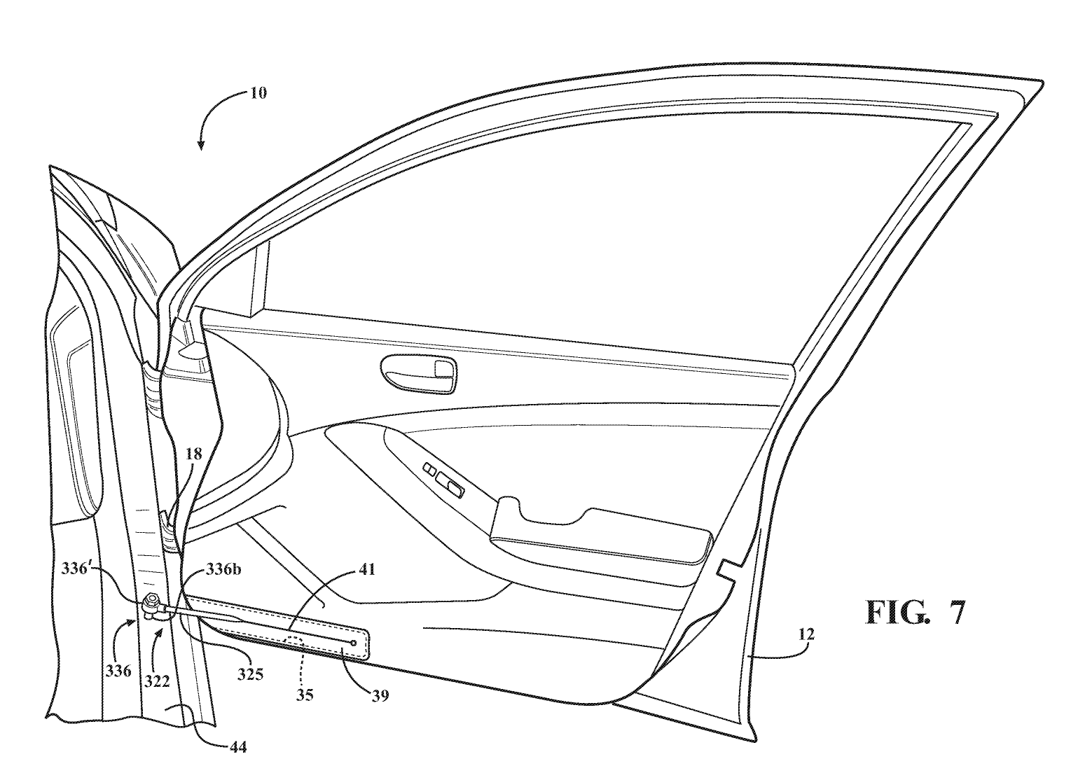

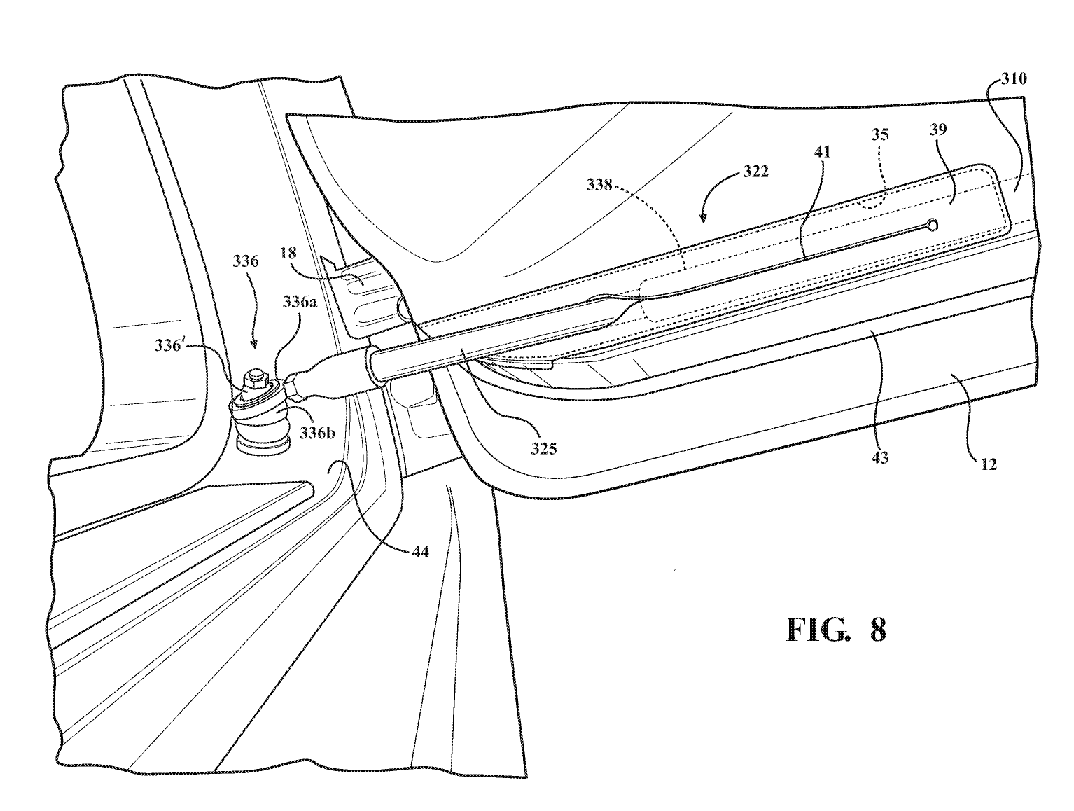

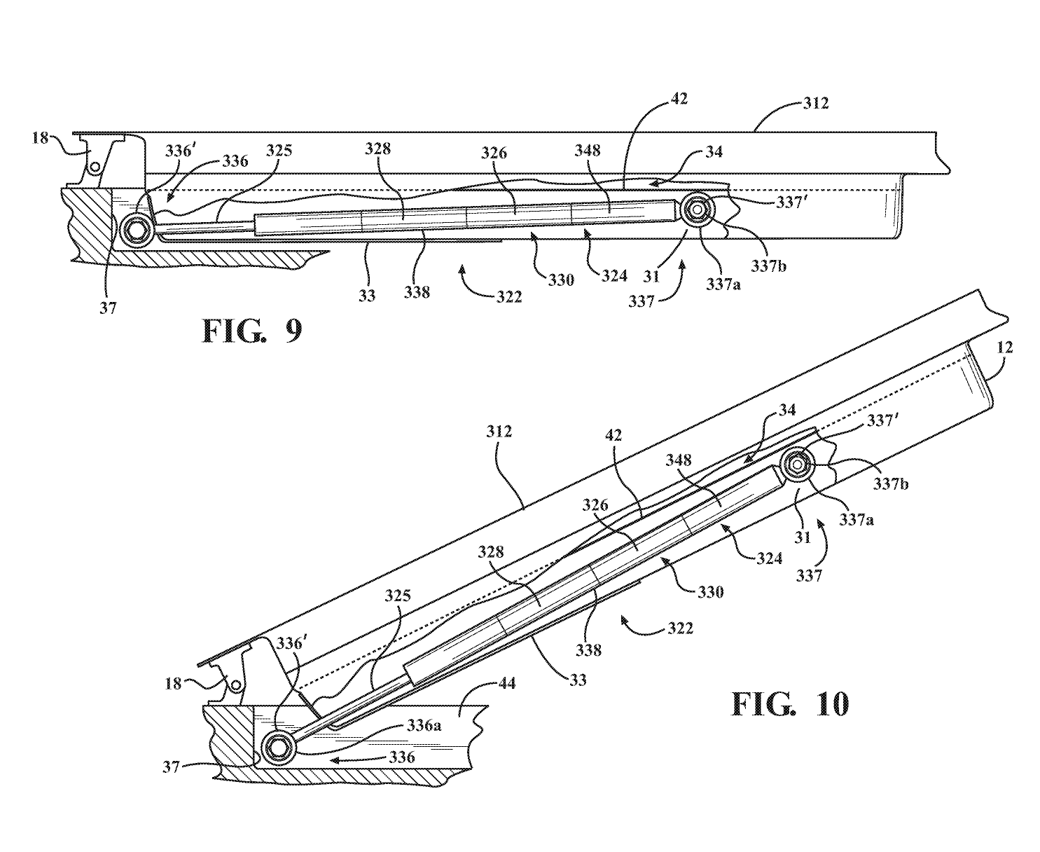

Now referring to FIG. 8, an aperture 35 is illustratively shown as provided along a bottom, front portion (toward A-pillar) of the inner panel 310 of the door 12 upstanding from floor 31, corresponding to the dry side of internal module carrier panel 42 which will be sealed from the external environment by the existing door seals 43 which run along the periphery of the door 12 for engaging in a sealing manner with the body 14 when the door 12 is closed. It is recognized that the location of the aperture 35 on the dry side of the door 12 does not suffer the drawbacks of an actuator opening on the wet side of the door 12, which is present between internal module carrier panel 42 (FIGS. 9-11) and the outer panel 312, which would require additional seals between the power swing door drive actuator 322 and the door 12. The aperture 35 is designed to allow a portion of the extensible actuation member 325 to pass there through during the extension and retraction extensible actuation member 325 so that the inner panel 310 does not interfere with the pivoting movement of the extensible actuation member 325. The pivoting movement of the movement of extensible actuation member 325 relative to the inner panel 310 is illustratively shown in FIGS. 9-11. As best illustrated in FIGS. 7 and 8, a boot, referred to hereafter as cover 39, may be provided to seal the aperture 35 from dust, debris and water from entering the cavity 34. The cover 39 may be provided with an opening, referred to hereafter as port 41, wherein port 41 can be provided in the form of a closed (meaning opposite edges of the slit abut one another) or substantially closed slit (meaning opposite edges of the slit are immediately adjacent, but slight spaced from one another) configured to receive the extension member 325 therethrough and to perfect or provide sealing there against so as not restrict movement of the extension member 325, yet allow the aperture 35 to be sealed against the ingress of contamination. The cover 39 may be formed from a plastic, vinyl, leather, rubber or other flexible, resilient material.

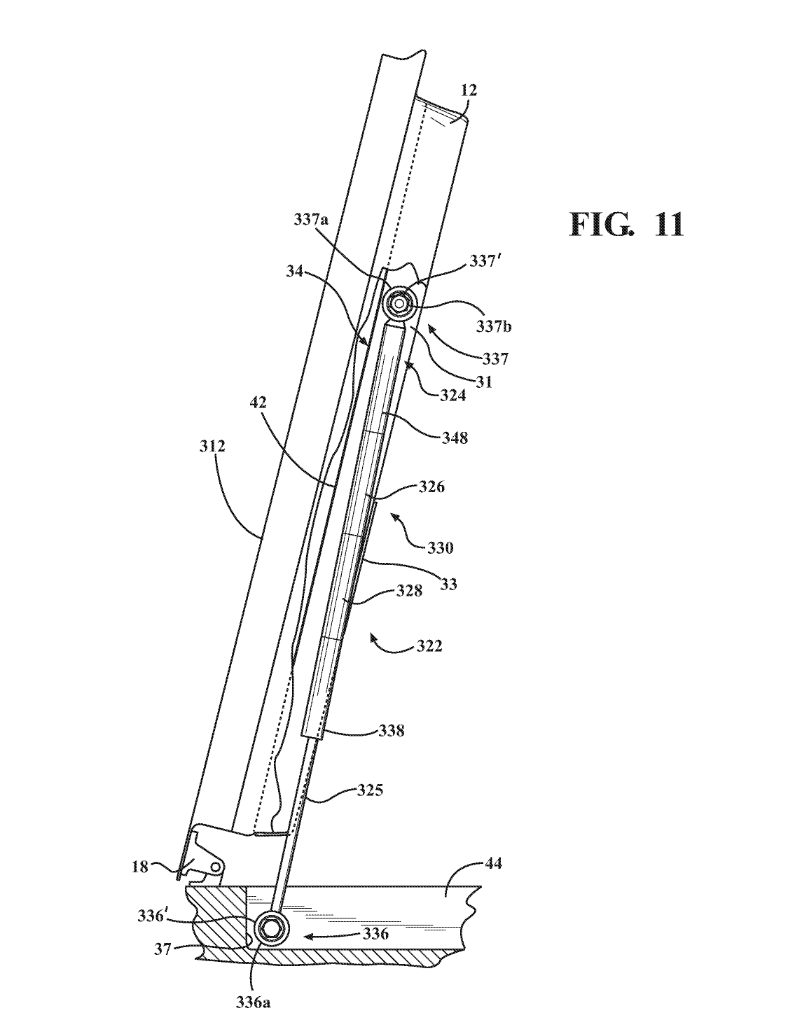

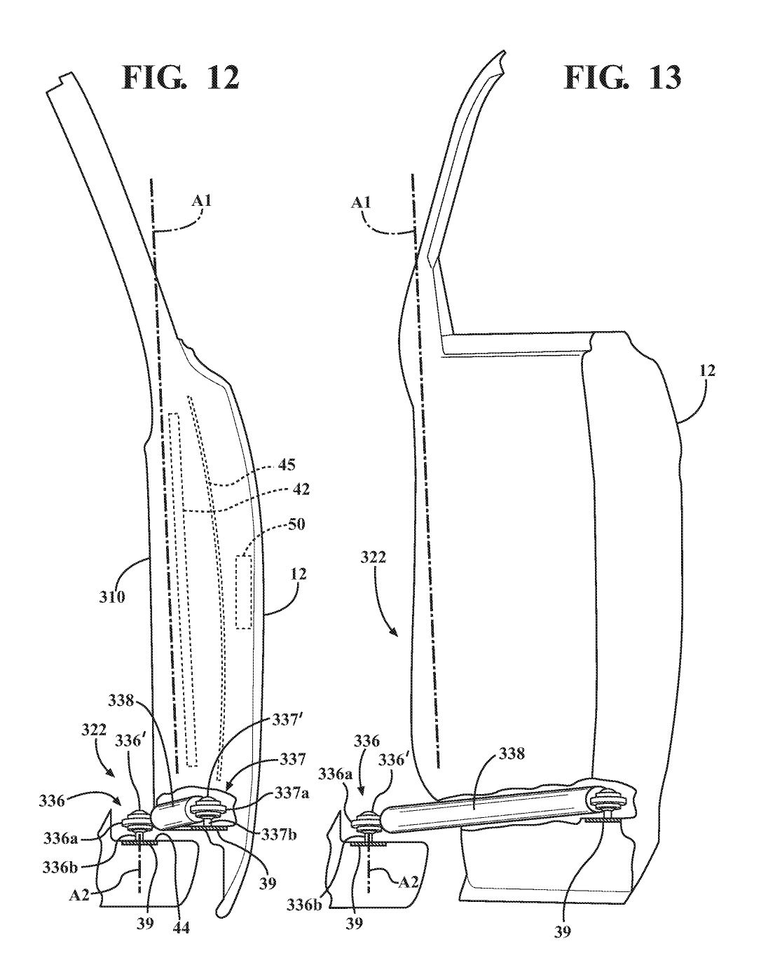

FIGS. 9-11 provide top views of power swing door drive actuator 322 when door 12 is closed, opened to an intermediate position and fully opened, respectively. FIG. 9 illustrates extensible actuation member 325 retracted relative to housing 314 when door 12 is closed. This is caused by linear movement of the drive nut on rotary leadscrew in a closing direction. In contrast, FIG. 10 illustrates extensible actuation member 325 partially extended relative to housing 338 when swing door 12 is opened to an intermediate position, while FIG. 11 illustrates extensible actuation member 325 fully extended relative to housing 338 when swing door 12 is fully opened. This is caused by linear movement of the drive nut along the rotary leadscrew in an opening direction. FIGS. 12 and 13 provide corresponding side views with swing door 12 closed and opened respectively. It is recognized that a power swing door drive actuator 322 having a longer stroke between a fully retracted state and fully extended state can thus be provided to occupy the space along a portion, or the entire or most of the lower portion of the door 12 where other components, such as those discussed above, including hardware associated with a window 45, including slide rails/glass run channels 46, lifter plates 48, anti-intrusion beams 50, and the like, will not interfere with the power swing door drive actuator 322 due to its positioning thereat.

Power swing door drive actuator 322 is preferably a linear-type power-operated device having an extensible cylindrical tube or rod, so as to define an electromechanical strut of the type generally similar to devices used in liftgate actuators, however without the requirement of a counterbalance spring. Power swing door drive actuator 322 is located at the bottom of the door cavity 34, generally below lower hinge 18 in a generally horizontal orientation. As discussed above, this placement prevents interference with other door-mounted objects (i.e. window regulators, glass, speakers, etc.). Forward connection (pointing toward a front end of vehicle 10) power swing door drive actuator 322 is fixed via first spherical joint unit 336 on the body side of vehicle 10 while its rearward connection (pointing toward a rear end of vehicle 10) is fixed via second spherical joint 337 along the bottom of interior cavity 334 of door 12. The spherical joint units 336, 337 provide multi-axis movement along X, Y and Z axes which is superior to a single axis pivotal connection.

Power swing door actuator 322 provides both push and pull forces to operate the power door system, particularly for passenger-type doors on motor vehicles. While power swing door drive actuator 322 provides an electrical “checking” function, it is contemplated that a mechanical checklink systems could easily be integrated with power swing door drive actuator 322. Additionally, articulating first and second coupling mechanisms 336 and 337, when combined with a mechanical checking mechanism, allows the power-operated swing door 12 to have the same translating path as a non-powered checklink arrangement. Articulating joint units 336′, 337′ allow the checklink path to follow the same path as conventional checklink configurations, rather than a linear path. Integrating a checklink mechanism into power swing door actuator 322 would also permit elimination of a separate door check feature. While power swing door actuator 322 has been described having power-operated drive mechanism 330 configured to convert rotary motion of the electric motor into linear, non-rotary motion of extensible actuation member 325, those skilled in the art will appreciate that alternative linear actuators could be used such as, for example, an electromagnetic solenoid-type linear actuator.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power swing door drive actuator for pivoting a vehicle swing door relative to a vehicle body between a closed position and an open position, the power swing door drive actuator comprising:
a power-operated drive mechanism having a housing and an extensible actuation member linearly moveable relative to the housing;
a first articulating joint mechanism pivotably connecting the extensible actuation member to the vehicle body; and
a second articulating joint mechanism pivotably connecting the housing to the vehicle swing door,
wherein the first articulating joint mechanism is configured to couple an end of the extensible actuation member to a door sill of the vehicle body, and wherein the second articulating joint mechanism is configured to couple the housing to the vehicle swing door.

2. The power swing door drive actuator of claim 1, wherein linear movement of the extensible actuation member in a first direction causes movement of the vehicle swing door in an opening direction from the closed position toward the open position and linear movement of the extensible actuation member in a second direction causes movement of the vehicle swing door in a closing direction from the open position toward the closed position, and wherein the power-operated drive mechanism is configured to be positioned in its entirety within a lowermost region of an internal cavity formed in the vehicle swing door.

3. The power swing door drive actuator of claim 2, wherein the power-operated drive mechanism includes an electric motor, and a spindle drive unit having a rotary drive member rotatably driven by the electric motor, wherein rotation of the rotary drive member, in a first rotary direction, causes linear movement of the extensible actuation member in the first direction, and wherein rotation of the rotary drive member, in a second rotary direction, causes linear movement of the extensible actuation member in the second direction.

4. The power swing door drive actuator of claim 3, wherein the extensible actuation member is in coaxial alignment with an axis of rotation of the rotary drive member and is located in a retracted position relative to the housing when the vehicle door is located in the closed position, wherein rotation of the rotary drive member in the first rotary direction causes the extensible actuation member to move linearly in the first direction from the retracted position toward an extended position relative to the housing for moving the vehicle swing door from the closed position to the open position, and wherein rotation of the rotary drive member in the second rotary direction causes the extensible actuation member to move linearly in the second direction from the extended position toward the retracted position for moving the vehicle swing door from the open position to the closed position.

5. The power swing door drive actuator of claim 1, wherein the first articulating joint mechanism includes a first spherical joint unit.

6. The power swing door drive actuator of claim 5, wherein the second articulating joint mechanism includes a second spherical joint unit.

7. The power swing door drive actuator of claim 1, wherein the power-operated drive mechanism further includes a geartrain unit driven by the electric motor and a slip clutch unit releasably coupling the geartrain unit to a leadscrew.

8. The power swing door drive actuator of claim 7, wherein the slip clutch unit is operable without the application of electric power to drivingly connect an output member of the geartrain unit to an input segment of the leadscrew, and wherein the slip clutch unit is operable with the application of electric power to disconnect the output member of the geartrain unit from the leadscrew.

9. The power swing door drive actuator of claim 8, wherein non-actuation of the electric motor when the vehicle swing door is located intermediate to its closed and fully open positions provides a door checking feature holding the vehicle swing door in an intermediate open position.

10. The power swing door drive actuator of claim 1, wherein said first articulating joint mechanism is configured for attachment to a region of the door sill in laterally spaced relation from a pivot axis of the vehicle swing door.

11. A power swing door drive actuator and vehicle therewith, the power swing door actuator being configured to pivot a vehicle swing door of the vehicle about a swing door pivot axis relative to a vehicle body between a closed position and an open position, the power swing door drive actuator comprising:
a power-operated drive mechanism having a housing and an extensible actuation member linearly moveable relative to the housing;
a first articulating joint mechanism pivotably connecting the extensible actuation member to a door sill of the vehicle body; and
a second articulating joint mechanism pivotably connecting the housing to the vehicle swing door,
wherein linear movement of the extensible actuation member in a first direction causes movement of the vehicle swing door in an opening direction from the closed position toward the open position and linear movement of the extensible actuation member in a second direction causes movement of the vehicle swing door in a closing direction from the open position toward the closed position.

12. The power swing door drive actuator and vehicle of claim 11, wherein the vehicle swing door has in internal cavity bounded at least in part by an inner panel, an outer panel and a floor extending between said inner and outer panels, said floor delimiting a lowermost region of said internal cavity, wherein the power-operated drive mechanism is configured to be positioned in its entirety within the lowermost region of said internal cavity.

13. The power swing door drive actuator and vehicle of claim 12, wherein said housing of said power-operated drive mechanism is fixed immediately adjacent said floor.

14. The power swing door drive actuator and vehicle of claim 13, wherein said housing of said power-operated drive mechanism is fixed to said floor.

15. The power swing door drive actuator and vehicle of claim 11, wherein said first articulating joint mechanism is configured for attachment to a region of said door sill in laterally spaced relation from said swing door pivot axis.

16. The power swing door drive actuator and vehicle of claim 11, wherein said first articulating joint mechanism includes a first spherical joint unit.

17. The power swing door drive actuator and vehicle of claim 16, wherein said second articulating joint mechanism includes a second spherical joint unit.

18. The power swing door drive actuator and vehicle of claim 12, wherein said inner panel has an aperture through which said extensible actuation member extends, said aperture being located below glass run channels on a dry side of said internal cavity.

19. The power swing door drive actuator and vehicle of claim 18, further including a cover extending over said aperture, said cover having an opening through which said extensible member extends.

20. The power swing door drive actuator and vehicle of claim 19, wherein the cover is a flexible material configured for sealing abutment with said extensible member.
